(19) United States
(12) Patent Application Publication
(10) Pub. No.: US 2006/0279032 A1
(43) Pub. Date: Dec. 14, 2006

(54) Threaded pad

(75) Inventor: Chien-Hsu Chen, Taipei City (TW)

Correspondence Address: BACON & THOMAS, PLLC, 625 SLATERS LANE, FOURTH FLOOR, ALEXANDRIA, VA, 22314, US

(73) Assignee: Hannspree, Inc., Taipei City (TW)

(21) Appl. No.: 11/221,911

(22) Filed: Sep. 9, 2005

(30) Foreign Application Priority Data
Jun. 9, 2005 (TW) 094209600

(51) Int. Cl. F16F 1/36

(52) U.S. Cl. 267/292; 267/153

(57) ABSTRACT

The present invention is to provide a threaded pad including a rod body made of a first material and a covering section made of a second material, and the second material being softer than the first material, wherein the covering section fully covers a head section disposed at the top of the rod body, and a threaded section is disposed around the periphery of the rod body, such that the threaded section can be used to screw the pad to the bottom of various electronic products, machines, equipments or furniture, and the pad made of a softer second material can prevent the floor or disposing surface from being scratched or damaged when the electronic products, machines, equipments or furniture is disposed or moved.

### FIELD OF THE INVENTION

The present invention relates to a threaded pad, and more particularly to a threaded pad including a rod body made of a first material and a covering section made of a second material, both manufactured by injection molding.

### BACKGROUND OF THE INVENTION

Referring to FIG. 1 for a prior art threaded pad, the thread pad is installed at the bottom of various different supports or devices. The pad 1 comprises a metal rod body 10 and a rubber head section 12, wherein a threaded section 14 is disposed around the rod body 10, and the head section 12 is disposed at the top of the rod body 10, such that the threaded section 14 screws the pad body 1 to the bottom of various different supports or devices. It prevents scratches or damages to the floor or a disposing surface when the supports or device is placed or moved.

The prior art threaded pad 1 is manufactured by producing the rod body 10 and the threaded section 14 first, and then connecting the head section 12 to the top of the rod body 10 by injection molding so as to complete the pad body 1; wherein the head section 12 uses a mold set for the manufacture, and the mold set comprises a first mold and an accommodating groove is disposed on one side of the second mold for accommodating a part of the rod body 10, and a head section forming groove is disposed on the second mold facing the side of the first mold. With the closely engaged molds, the accommodating groove precisely faces the head section forming groove, such that after the rod body 10 is manufactured and to be attached to the threaded section 14, the rod body 10 is placed into the accommodating groove, then the molds are engaged and sealed to precisely expose the top of the rod body 10 from the head section forming groove. After a plastic material is heated, melted and injected into the head section forming groove through a plastic injection opening. The plastic material will cover the top of the rod body 10 to form the head section 12 and complete the manufacture of the pad 1.

The rod body 10 is easily to get rusted when expose to air because it is made of metal. As a result, it is very difficult to remove the pad 1 from the support or the device. Moreover, the rod body 10 and the threaded section 14 are manufactured according to the foregoing process, and thus it is difficult to control the size and tolerance. If the size of the rod body 10 is too large, then the rod body 10 will not fit into the accommodating groove, and thus will make the operation of covering the head section 12 difficult and lower the yield rate. If the size of the rod body 10 is too small, the rod body 10 will be loosened easily in the accommodating groove, and thus the plastic material covering the head section 12 The rod body 10 will be tilted by the injection pressure to produce a defected pad 1. Therefore, the foregoing and manufacturing process of the pad 1 produces a large quantity of defects and incurs unnecessary costs.

The pad 1 is manufactured by machines or injection molding, many different machines and equipments are needed in the manufacturing process. A large quantity of manpower is also required for its production. The productivity is low, and on the other hand, the manufacturing cost of the pad 1 becomes very high. Therefore, finding a way of manufacturing high-precision and rustproof threaded pad by a simple manufacturing process demands immediate attention.

### SUMMARY OF THE INVENTION

In view of the description above, the inventor of the present invention based on years of experience, also conducted extensive researches and experiments to improve the design and manufacturing process of the prior art threaded pad, and finally invented a threaded pad in accordance with the present invention.

An objective of the present invention is to provide a threaded pad that comprises a rod body made of a first material and a covering section made of a second material, and the second material is softer than the first material, wherein the covering section fully covers a head section disposed at the top of the rod body, and a threaded section is disposed around the periphery of the rod body, such that the threaded section can be used to screw the pad to the bottom of various electronic products, machines, equipments or furniture. The pad made of a softer second material can avoid the floor or disposing surface from being scratched and damaged when the electronic products, machines, equipments or furniture are disposed or moved.

### BRIEF DESCRIPTION OF THE DRAWINGS

FIG. 1 is a perspective view of a prior art threaded pad;

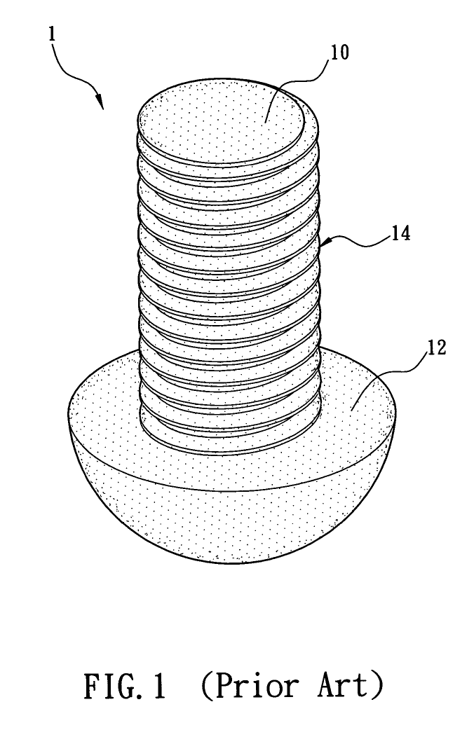

FIG. 2 is a perspective view of a threaded pad of the present invention;

FIG. 3 is a cross-sectional view of a threaded pad of the present invention;

FIG. 4 is a flow chart of manufacturing a threaded pad according to the present invention;

FIG. 5 is a schematic view of manufacturing a threaded pad by injection molding according to the present invention;

FIG. 6 is another schematic view of manufacturing a threaded pad by injection molding according to the present invention; and

FIG. 7 is a further schematic view of manufacturing a threaded pad by injection molding according to the present invention.

### DETAILED DESCRIPTION OF THE PREFERRED EMBODIMENTS

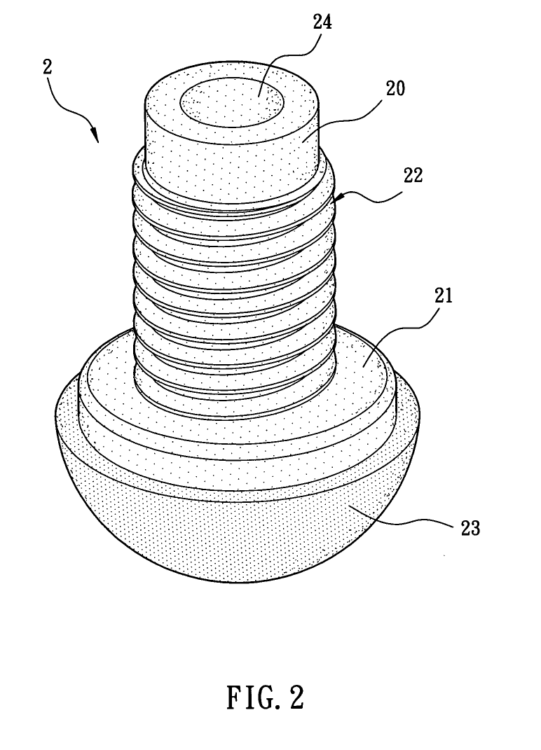

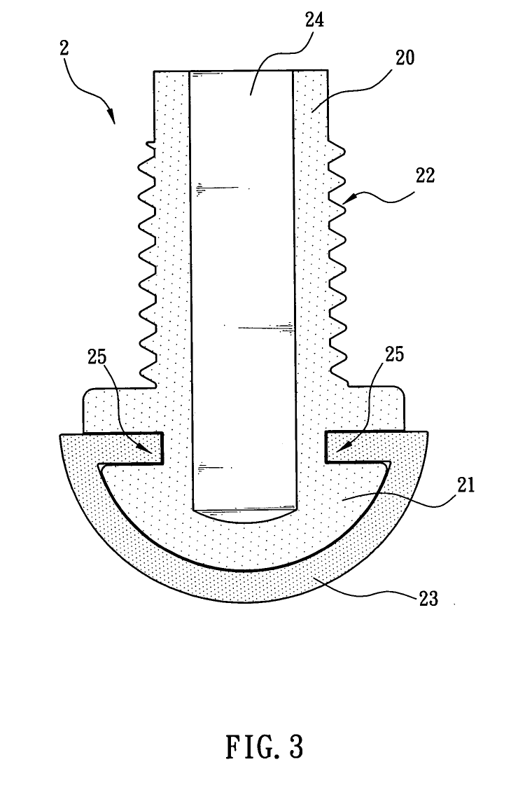

Referring to FIGS. 2 and 3 for the threaded pad according to a preferred embodiment of the present invention, the pad 2 comprises a rod body 20 and a covering section 23 respectively made of a first material and a second material, wherein a threaded section 22 is screwed around the periphery of the rod body 20, and a head section 21 is disposed at the top of the rod body 20. The covering section 23 is covered onto the head section 21, such that the threaded section 22 screws the pad 2 to various electronic products, machines and furniture.

Referring to FIG. 3 again for another preferred embodiment of the present invention, the rod body 20 further includes a hollow section 24, and the hollow section 24 is extended from the top of the rod body 20 to the bottom of the rod body 20 and an opening is formed at the bottom of the rod body 20. Also, the hollow section 24 is extended from the top to the interior of the head section 21. The hollow section 24 can prevent the threaded section from being deformed and the pad from being defected, since the cooling rate of the surface and the interior of the pad 2 are different during the injection molding of the pad 2, and the pad will be contracted unevenly.

Referring to FIG. 3 for the preferred embodiment of the present invention, a groove 25 is disposed around the head section 21, such that when the covering section 23 is formed on the head section 21 by injection molding, the groove 25 is provided for containing a heated and melted plastic material. The covering section 23 is formed after the plastic material is cooled. The covering section 23 not only covers the head section 21, but also fills the groove 25, such that the groove 25 is connected with the covering section 23, and the covering section 23 is closely covered onto the head section 21 without the risk of falling apart.

In the preferred embodiment, the hardness of the material (first material) of the rod body 20 is higher than the material (second material) of the covering section 23. In other words, the second material is softer than the first material, and the first material of the rod body 20 could be an ABS plastic material (made of Acrylonitrile, Butadiene, and Styrene), so that the pad 2 can be securely fixed onto the electronic products, machines, equipments, or furniture. The covering section 23 (second material) could be made of a softer material such as rubber, prevent the floor or a surface from being scratched or damaged when the electronic products, machines, equipments or furniture are placed or moved.

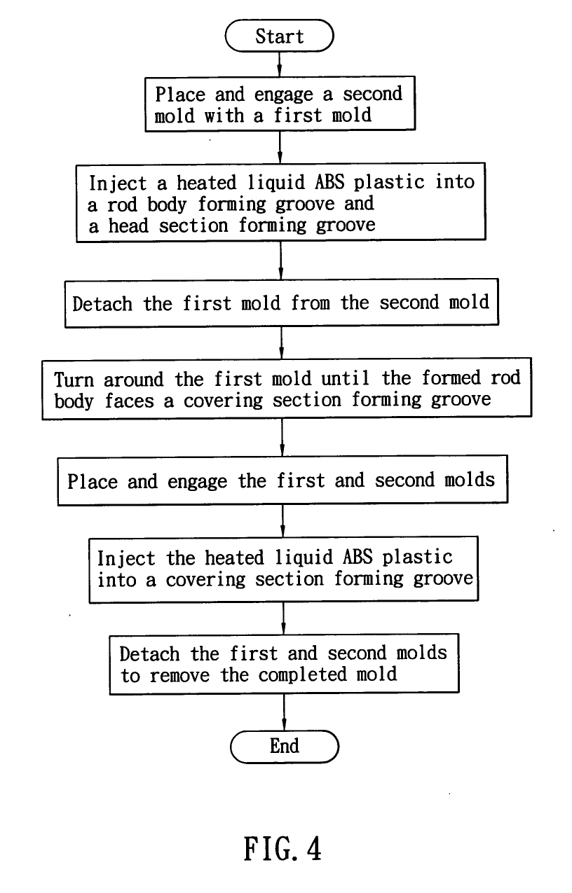

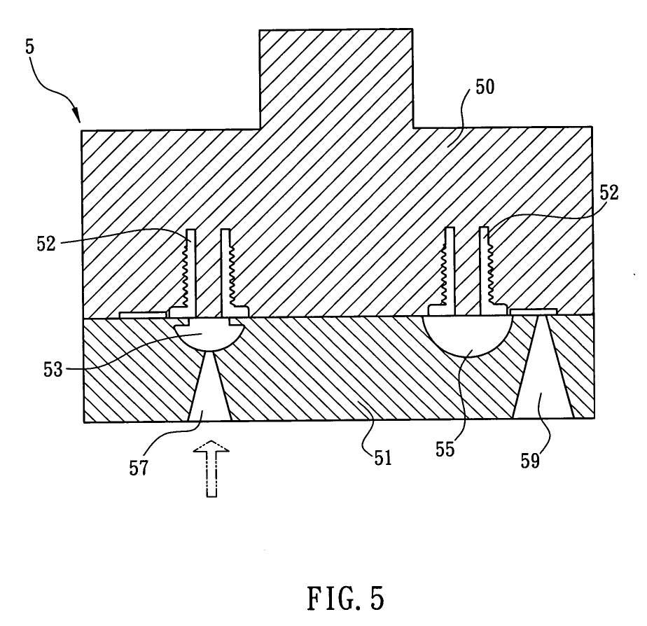

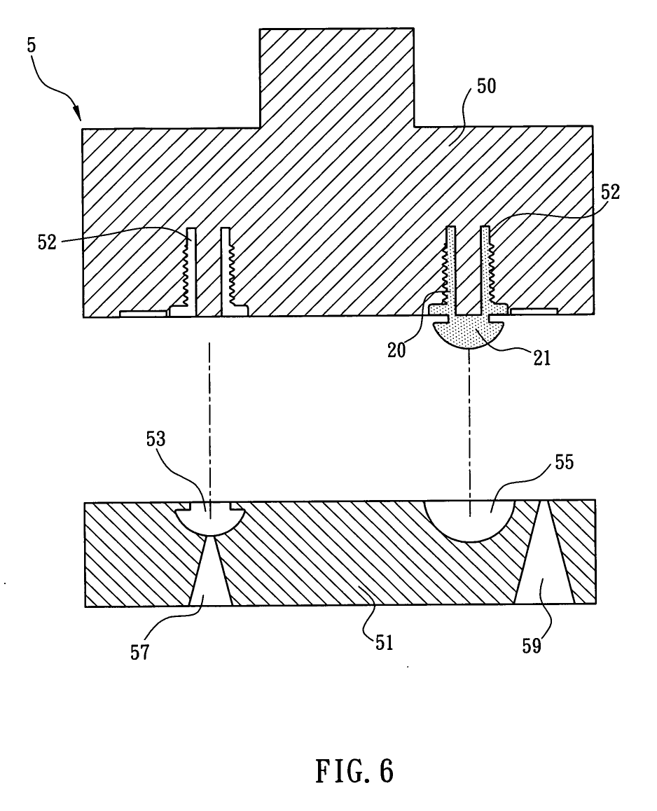

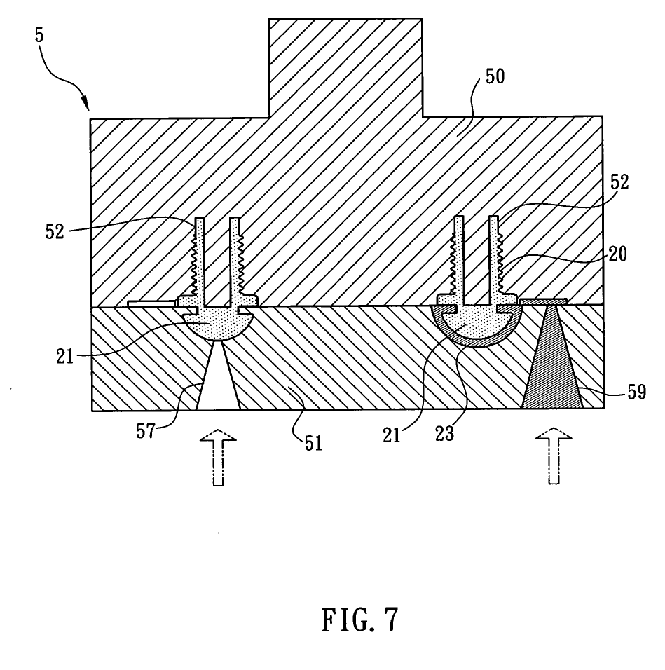

Referring to FIGS. 4 to 6 for the preferred embodiment, the pad is manufactured by a mold set 5 by injection molding, and the mold set 5 comprises a first mold 50 and a second mold 51, and the first mold 50 includes two rod body forming grooves 52, and the second mold 51 includes a head section forming groove 53 and a covering section forming groove 55. The head section forming groove 53 is connected to a plastic injection opening 57, and the covering section forming groove 55 is connected to another plastic injection opening 59, so that when the pad 2 is manufactured, the first mold 50 and the second mold 51 are closely engaged with each other, and the rod body forming groove 52 precisely faces the head section forming groove 53. A heated and melted ABS plastic material is injected into the rod body forming groove 52 and the head section forming groove 53 through the plastic injection opening 57 to complete the formation of the rod body 20 as shown in FIG. 5. Referring to FIG. 6, the first mold 50 is separated from the second mold 51, and the first mold 50 is turned around to turn the rod body forming groove 52 and the rod body 20 in the rod body forming groove 52 into a position precisely facing the position of the covering section forming groove 55, and then the first mold 50 and the second mold 51 are engaged closely with each other. The heated and melted rubber is injected into the covering section forming groove 55 through another plastic injection opening 59, so that the covering section 23 is formed and covered onto the head section 21 as shown in FIG. 7, and then the first mold 50 is detached from the second mold 51 to remove the finished pad 2. Therefore, it is not necessary to go through two different manufacturing processes including the manufacturing by machine and the injection molding as it does in the prior art. The invention only uses injection molding for manufacturing the pad 2, and thus can greatly reduce the defective rate.

Referring to FIGS. 6 and 7 for this preferred embodiment, the rod body forming groove 52 and the rod body 20 in the rod body forming groove 52 precisely face the covering section forming groove 55, so that the covering section 23 can be formed and covered onto the head section 21, and the head section forming groove 53 faces another rod body forming groove 52. By that time, the heated and melted ABS material can be injected simultaneously into the rod body forming groove 52 and the head section forming groove 53 to complete the injection molding of another rod body 20, and then the first mold 50 is detached from the second mold 51 to remove the finished pad 2. The first mold is turned around to correspond the foregoing other rod body 20 to the covering section forming groove 55, so as to form the covering section 23 and produce a second pad. By the repeated steps of the manufacturing process, the mold 5 can be used repeatedly for the manufacture of the pad 2, and thus it can greatly improve productivity.

By the foregoing designs for the structure, shape and manufacturing process of the pad, the present invention can achieve the following objectives and effects.

1. The manufacturing method of the pad according to the present invention is different from the manufacturing process of the prior art pad. The invention can avoid the error of the rod body caused by the manufacture by machines. Such error will give a result that the rod body cannot be placed into the molds, or placed into the correct position of the molds. Since the rod body cannot be fixed properly, a tilted covering or a defect will be formed when the rod body is covered. Therefore, the present invention can greatly improve the precision of the pad.

2. The pad of the invention is made by the injection molding to avoid the rod body of a prior art pad from being rusted by oxidation. If the pad is screwed onto the bottom of various electronic products, machines, equipments, or furniture, the removal operation can be carried out successfully.

3. With the design of the hollow section, the deformation of the threaded section 22 caused by the different cooling rate of the interior and the exterior of the pad after the injection molding can be avoided. The present invention can reduce the defective rate of the pad, save materials, and effectively lower manufacturing costs.

4. Since the pad is manufactured by the mold set placed on an injection machine, the productivity can be improved and the cost of labor and machinery can be greatly reduced. In addition, the product can be manufactured with various patterns and be treated with different colors, so that the final product can have an artistic appearance.

What is claimed is:

1. A threaded pad, comprising:
a rod body, made of a first material and the periphery of said rod body being screwed with a threaded section, and having a head section disposed at the top of said rod body; and
a covering section, made of a second material and being covered onto said head section.

2. The threaded pad of claim 1, wherein said rod body includes a hollow section therein, and said hollow section is extended from the top of said rod body to the bottom, and an opening is formed at the bottom of said rod body, and the hollow section is extended from the top to the interior of said head section.

3. The threaded pad of claim 1, wherein said head section includes a groove disposed around the periphery of said head section and said groove is coupled to said covering section.

4. The threaded pad of claim 1, wherein said first material is an ABS plastic.

5. The threaded pad of claim 1, wherein said second material is rubber.

6. The threaded pad of claim 1, wherein said second material is softer than said first material.
